(19) United States
(12) Patent Application Publication
(10) Pub. No.: US 2022/0377230 A1
(43) Pub. Date: Nov. 24, 2022

(54) REMOTE MONITORING DEVICE AND REMOTE MONITORING METHOD THEREOF

(71) Applicant: Egis Technology Inc., Hsinchu City (TW)

(72) Inventor: Gong-Yi Lin, Hsinchu City (TW)

(73) Assignee: Egis Technology Inc., Hsinchu City (TW)

(21) Appl. No.: 17/709,334

(22) Filed: Mar. 30, 2022

Related U.S. Application Data
(60) Provisional application No. 63/190,747, filed on May 19, 2021.
(60) Provisional application No. 63/194,193, filed on May 28, 2021.

(30) Foreign Application Priority Data
Nov. 16, 2021 (CN) 202111357605.2

(51) Int. Cl. H04N 5/232; H02S 50/10; H02S 40/38; G03B 17/56; H04N 5/225

(52) U.S. Cl. CPC H04N 5/23206; H02S 50/10; H02S 40/38; G03B 17/561; H04N 5/2256

(57) ABSTRACT

A remote monitoring device and a remote monitoring method thereof are provided. An energy harvesting device converts energy harvested from the surrounding environment into electrical energy for storage. An image capturing device captures an image of a monitored object to generate a captured image. When the power stored in the energy harvesting device meets a preset condition, a control circuit outputs monitoring information based on the captured image.

### CROSS-REFERENCE TO RELATED APPLICATION

This application claims the priority benefit of U.S. Provisional application No. 63/190,747, filed on May 19, 2021, U.S. Provisional application No. 63/194,193, filed on May 28, 2021, and China application no. 202111357605.2, filed on Nov. 16, 2021. The entirety of each of the above-mentioned patent applications is hereby incorporated by reference herein and made a part of this specification.

### BACKGROUND

### Technical Field

The disclosure relates to a monitoring device, particularly to a remote monitoring device and a remote monitoring method thereof.

### Description of Related Art

Conventional meters like electricity, water, and gas meters are mostly rely on on-site monitoring or manual meter reading to record the information for regulation or billing, which is not ideal for management efficiency and cost. Therefore, it is a problem unsolved to improve the information collection of the meter.

### SUMMARY

The present disclosure provides a remote monitoring device and a remote monitoring method thereof capable of improving the monitoring efficiency and cost effectively.

The remote monitoring device of the disclosure includes an energy harvesting device, an image capturing device, and a control circuit. The energy harvesting device converts the energy harvested from the surrounding environment into electrical energy for storage. The image capturing device is coupled to the energy harvesting device, and captures the image of a monitored object to generate a captured image. The control circuit is coupled to the energy harvesting device and the image capturing device, and outputs monitoring information based on the captured image when the power stored in the energy harvesting device meets a preset condition.

The disclosure also provides a remote monitoring method of a remote monitoring device. The remote monitoring device includes an energy harvesting device and an image capturing device. The energy harvesting device converts the energy harvested from the surrounding environment into electrical energy for storage. The remote monitoring method of the remote monitoring device includes the following steps. The image capturing device is controlled to capture the image of a monitored object to generate a captured image. It is determined whether the power stored in the energy harvesting device reaches a preset power level. And when the power stored in the energy harvesting device meets a preset condition, the monitoring information is output based on the captured image.

Based on the above, in the embodiments of the disclosure, the energy harvesting device converts the energy harvested from the surrounding environment into electrical energy for storage, and the control circuit outputs monitoring information based on the captured image provided by the image capturing device when the power stored in the energy harvesting device meets a preset condition. As the energy harvesting device provides the power for the remote monitoring device to operate, and the monitoring information is automatically output based on the captured image when the power stored in the energy harvesting device meets a preset condition, the information is no longer needed to be recorded on-site manually as in the prior art. Moreover, since the electric energy may be obtained from the environment, there is no need to replace a power supply with another, and thus the monitoring efficiency and cost may be improved effectively.

### BRIEF DESCRIPTION OF THE DRAWING

FIG. 1 is a schematic diagram of a remote monitoring device according to an embodiment of the disclosure.

FIG. 2 is a schematic diagram of a remote monitoring device according to another embodiment of the disclosure.

FIG. 3 is a schematic diagram of an illuminating light source configured according to an embodiment of the disclosure.

FIG. 4 is a schematic diagram of a remote monitoring device according to another embodiment of the disclosure.

FIG. 5 is a schematic diagram of a remote monitoring device according to yet another embodiment of the disclosure.

FIG. 6 is a flowchart of a remote monitoring method of a remote monitoring device according to an embodiment of the disclosure.

FIG. 7 is a flowchart of a remote monitoring method of a remote monitoring device according to another embodiment of the disclosure.

### DESCRIPTION OF THE EMBODIMENTS

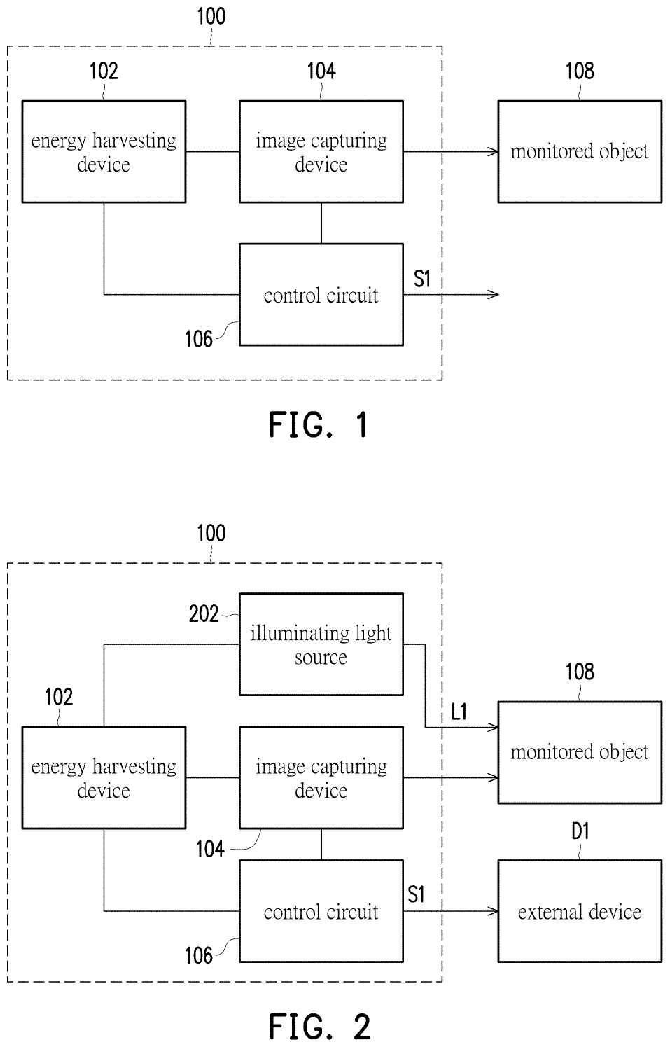

FIG. 1 is a schematic diagram of a remote monitoring device according to an embodiment of the disclosure. As shown in FIG. 1, a remote monitoring device 100 may include an energy harvesting device 102, an image capturing device 104, and a control circuit 106. The energy harvesting device 102 is coupled to the image capturing device 104 and the control circuit 106. The image capturing device 104 is coupled to the control circuit 106. The energy harvesting device 102 converts the energy, such as solar energy, ambient thermal energy, electromagnetic wave energy, harvested from the surrounding environment into electrical energy for storage. Specifically, the energy harvesting device 102 may be, for example, a solar panel with an energy storage device (such as a battery), but it is not limited thereto, and it may also be, for example, a thermal gradient energy harvester, a vibration (piezoelectric) energy harvester, or a radio frequency (RF) energy harvester.

The image capturing device 104 may capture the image of a monitored object 108 to generate a captured image. The captured image may be a still image or a moving image. And the timing of capturing the image of the monitored object 108 using the image capturing device 104 may depend on, for example, the amount of power stored in the energy harvesting device 102. For example, when the power stored in the energy harvesting device 102 reaches a power level required by the image capturing device 104 to capture an image, the image capturing device 104 captures the image of the monitored object 108. Alternatively, when the power stored in the energy harvesting device 102 is sufficient, the image capturing device 104 may capture images of the monitored object 108 periodically, that is, it captures images of the monitored object 108 at predetermined intervals. The image capturing device 104 may be, for example, a CMOS image sensor or a CIS image sensor, but the disclosure is not limited thereto. In other embodiments, the image capturing device 104 may also be implemented as an event camera to capture images of the monitored object 108 according to pixel changes detected by the event camera. As the event camera only captures images when pixel changes are detected, power consumption may be reduced.

The control circuit 106 outputs monitoring information 51 based on the captured image when the power stored in the energy harvesting device 102 meets a preset condition (for example, when the power stored in the energy harvesting device 102 reaches a preset power level required for the operation of the control circuit 106 (such as analyzing images, capturing images, and data transmission control), but the disclosure is not limited thereto. The monitoring information S1 may be output to, for example, a data storage device for storage, but the disclosure is not limited thereto. In some embodiments, the control circuit 106 may also periodically output the monitoring information S1 based on the captured images. For example, the control circuit 106 outputs the monitoring information S1 based on the captured images at predetermined intervals. For another example, the control circuit 106 analyzes the captured image generated by the image capturing device 104, so that when there is a difference between the captured image currently captured and the captured image captured last time by the image capturing device 104, the monitoring information S1 is output based on the currently captured image.

Furthermore, the control circuit 106 may interpret the relevant information of the monitored object 108 based on the content of the captured image. For example, in the case where the monitored object 108 is a meter, the control circuit 106 may interpret the position of a pointer of the meter or the numbers displayed on the meter based on the captured image, and generate interpretation information, such as electricity consumption, water consumption, temperature, or carbon dioxide concentration. For another example, in the case where the monitored object 108 is an indoor space, the control circuit 106 may determine the identity of the person entering the indoor space based on the captured image. The control circuit 106 may be implemented by, for example, an artificial intelligence chip, but the disclosure is not limited thereto. In the case where the control circuit 106 is implemented with an artificial intelligence chip, the control circuit 106 can determine the information contained in the captured image through artificial intelligence operations. In some embodiments, the monitoring information S1 may also include captured images besides the interpretation information, or the monitoring information S1 may also only include captured images.

As the energy harvesting device 102 provides the power for the image capturing device 104 and the control circuit 106 to operate, and the control circuit 106 automatically outputs the monitoring information S1 based on the captured image when the power stored in the energy harvesting device 102 meets a preset condition, the information of the monitored object is no longer needed to be recorded on-site manually as in the prior art. Moreover, since the power may be obtained from the surrounding environment by the energy harvesting device 102, there is no need to replace a power supply with another for the remote monitoring device 100, and thus the remote monitoring device 100 may improve the monitoring efficiency and cost effectively.

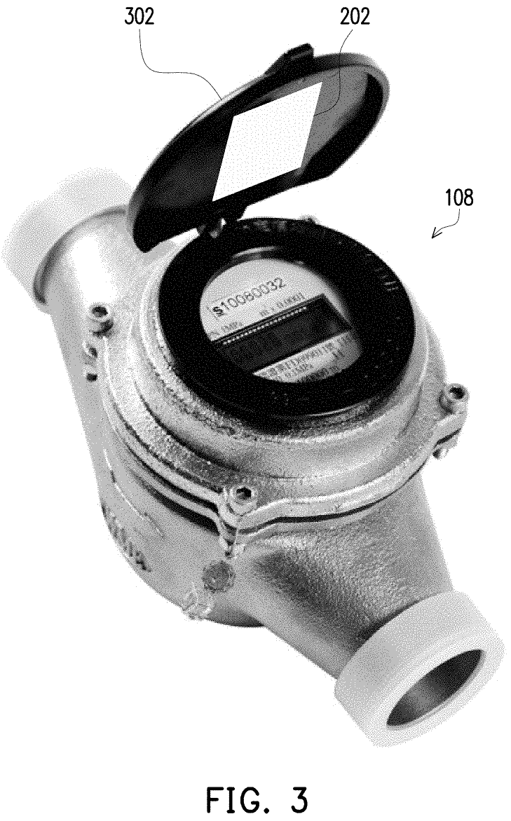

FIG. 2 is a schematic diagram of a remote monitoring device according to another embodiment of the disclosure. Compared with the embodiment of FIG. 1, the remote monitoring device 100 of this embodiment further includes an illuminating light source 202 coupled to an energy harvesting device 102. The illuminating light source 202 provides an illuminating light L1 to illuminate the monitored object 108 to help the image capturing device 104 obtain a clear captured image. For example, as shown in FIG. 3, in the case where the monitored object 108 is a meter with a cover 302, the illuminating light source 202 may be disposed on the cover 302 to illuminate the surface of the meter when the cover 302 is lifted, so that the image capturing device 104 can clearly capture the image of the display panel of the meter. In some embodiments, the illuminating light source 202 may also be disposed on the meter body, such as the display panel of the meter, to provide illuminating light, but it is not limited thereto. The illuminating light source 202 may be implemented by, for example, light-emitting diodes, but the disclosure is not limited thereto. In other embodiments, the illuminating light source 202 may also come from, for example, an illumination window on the cover, and the illumination window illuminates the surface of the meter by introducing ambient light. In addition, in this embodiment, the control circuit 106 transmits the monitoring information S1 to an external device D1. For example, the control circuit 106 transmits the monitoring information S1 to an external storage device (such as a hard disk or a memory card) through a wired local area network, but the disclosure is not limited thereto.

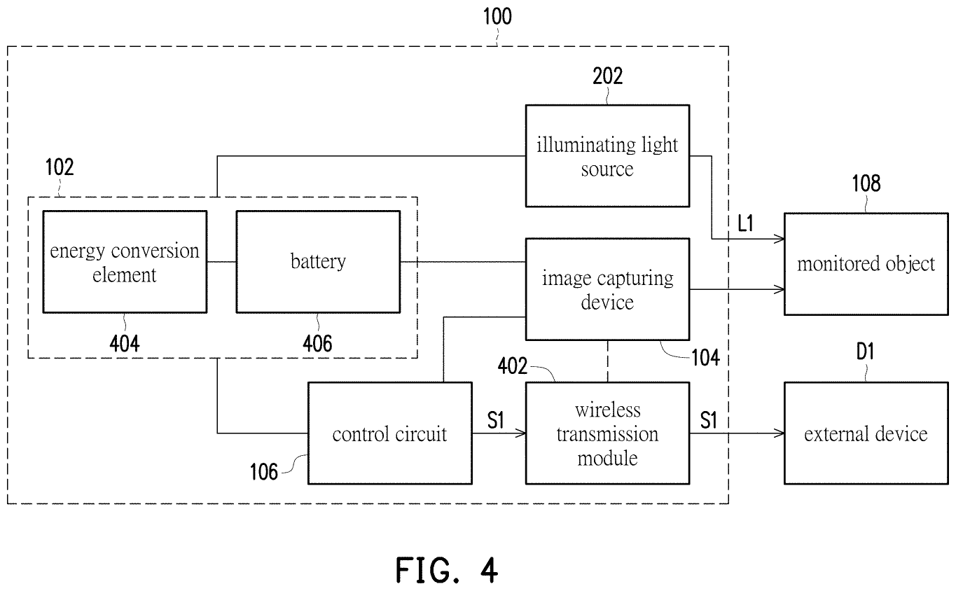

FIG. 4 is a schematic diagram of a remote monitoring device according to another embodiment of the disclosure. Compared with the embodiment of FIG. 2, the remote monitoring device 100 of this embodiment further includes a wireless transmission module 402. The wireless transmission module 402 is coupled to a control circuit 106. The wireless transmission module 402 may be, for example, a transmission module supporting the Bluetooth Low Energy (BLE) Mesh Networks or the long-range (LoRa), low-power wireless communication, but the disclosure is not limited thereto. The control circuit 106 transmits monitoring information S1 to an external device D1, such as a mobile phone or a tablet computer, through the wireless transmission module 402, but it is not limited thereto.

In some embodiments, the wireless transmission module 402 may also be coupled to an image capturing device 104 (as shown by the dotted line), so that after the image capturing device 104 completes capturing the image of the monitored object 108, it may transmit the captured image directly to the external device D1 through the wireless transmission module 402 without going through the control circuit 106. In addition, in this embodiment, the energy harvesting device 102 may include an energy conversion element 404 and a battery 406, and the energy conversion element 404 is coupled to the battery 406. The energy conversion element 404 converts the ambient energy into electrical energy, and the battery 406 stores the electrical energy provided by the energy conversion element 404. The energy conversion element 404 may be, for example, a solar panel, but the disclosure is not limited thereto.

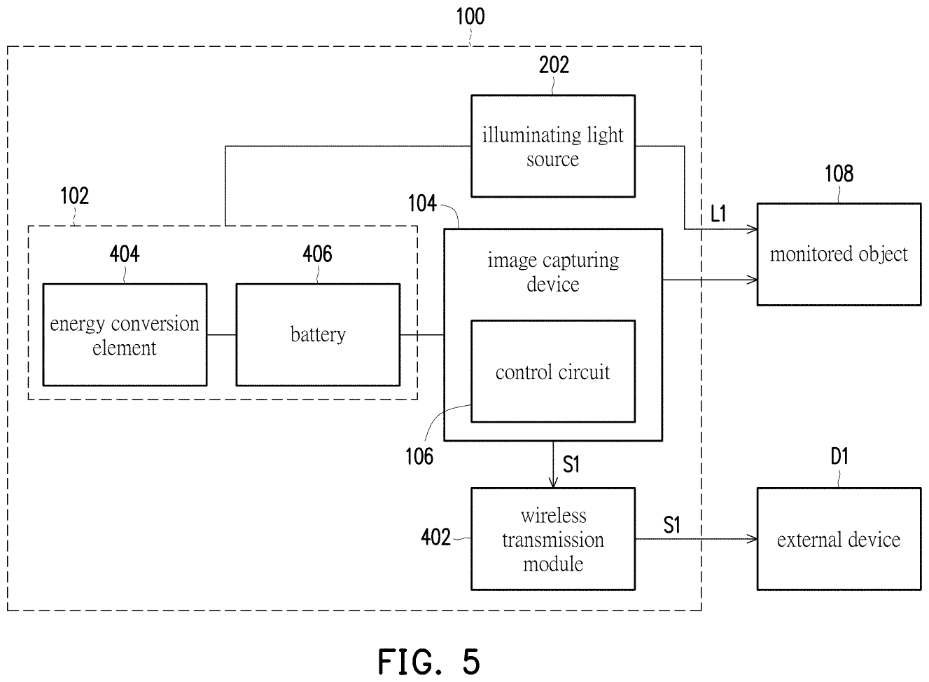

Moreover, in some embodiments, as shown in FIG. 5, the above-mentioned control circuit 106 is integrated in the image capturing device 104 to, for example, miniaturize the remote monitoring device. Since the implementations of the elements in the remote monitoring apparatus 100 in the embodiment of FIG. 5 re the same as those in the embodiment of FIG. 4, the same details are not repeated herein.

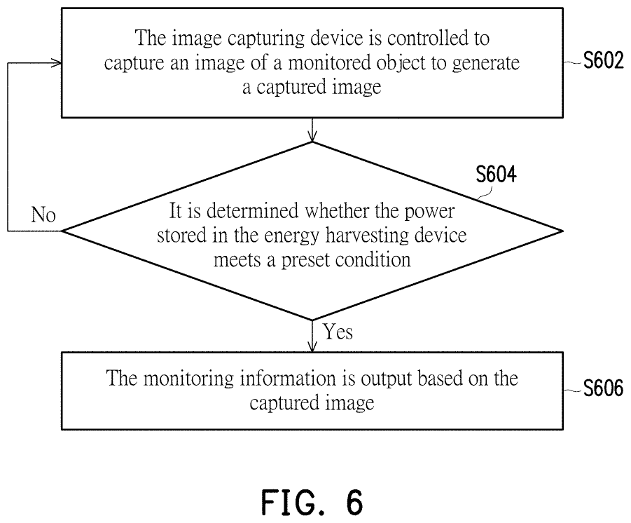

FIG. 6 is a flowchart of a remote monitoring method of a remote monitoring device according to an embodiment of the disclosure. The remote monitoring device includes an energy harvesting device and an image capturing device, and the energy harvesting device converts the energy harvested from the surrounding environment into electrical energy for storage. It may be known from the above embodiments that the remote monitoring method of the remote monitoring device may include the following steps. First, the image capturing device is controlled to capture an image of a monitored object to generate a captured image (step S602), and the image capturing device may be, for example, an event camera, but the disclosure is not limited thereto. Next, it is determined whether the power stored in the energy harvesting device meets a preset condition (step S604). For example, it is determined whether the power stored in the energy harvesting device reaches a preset power level, but the disclosure is not limited thereto. If the power stored in the energy harvesting device does not reach the preset condition, the process returns to step S602 to continue capturing images of the monitored object. If the power stored in the energy harvesting device meets the preset condition, monitoring information is output based on the captured image. The monitoring information may include at least one of the captured image and interpretation information obtained by interpreting the captured image. In some embodiments, whether to output the monitoring information based on the captured image may also be determined based on the analysis result of the captured image.

For example, it may be determined whether there is a difference between the captured image currently captured and the captured image captured last time by the image capturing device. When there is a difference between the captured image currently captured and the captured image captured last time by the image capturing device, the monitoring information is output based on the captured image currently captured.

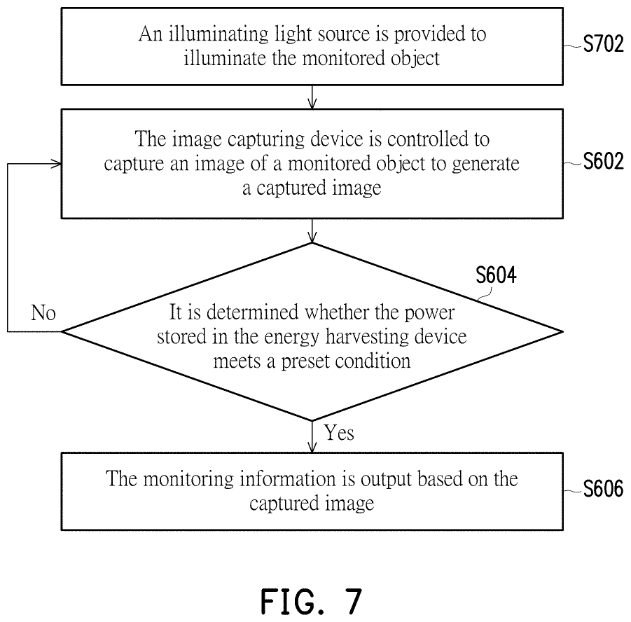

FIG. 7 is a flowchart of a remote monitoring method of a remote monitoring device according to another embodiment of the disclosure. The difference between this embodiment and the embodiment in FIG. 6 is that the remote monitoring method of the remote monitoring device of this embodiment may further include a step S702 of providing an illuminating light source to illuminate the monitored object before step S602 to help get a clearer captured image. For example, in the case where the monitored object is a meter with a cover, the illuminating light provided by the illuminating light source may be provided to the surface of the meter to help the image capturing device to capture a clear captured image. The illuminating light may be provided by, for example, an illuminating light source disposed on the meter body or the cover. The illuminating light source may be, for example, a light-emitting diode, but the disclosure is not limited thereto. In other embodiments, the illuminating light source may also be provided by, for example, an illuminating window on the cover that provides an illuminating light by introducing the ambient light.

To sum up, the energy harvesting device of the embodiment of the disclosure converts the energy harvested from the surrounding environment into electrical energy for storage, and the control circuit outputs monitoring information based on the captured image provided by the image capturing device when the power stored in the energy harvesting device meets a preset condition. As the energy harvesting device provides the electrical energy required for the remote monitoring device to operate, and the monitoring information is automatically output based on the captured image when the stored energy of the energy harvesting device meets a preset condition, the information is no longer needed to be recorded on-site manually as in the prior art. Moreover, since the electric energy may be obtained from the environment, there is no need to replace a power supply with another, and thus the monitoring efficiency and cost may be improved effectively.

What is claimed is:

1. A remote monitoring device, comprising:
an energy harvesting device, adapted to convert energy harvested from a surrounding environment into electrical energy for storage;
an image capturing device, coupled to the energy harvesting device, adapted to capture an image of a monitored object to generate a captured image; and
a control circuit, coupled to the energy harvesting device and the image capturing device, and adapted to output monitoring information based on the captured image when power stored in the energy harvesting device meets a preset condition.

2. The remote monitoring device as claimed in claim 1, wherein the control circuit outputs the monitoring information based on the captured image when the power stored in the energy harvesting device reaches a preset power level.

3. The remote monitoring device as claimed in claim 1, wherein the control circuit analyzes the captured image generated by the image capturing device, and the control circuit outputs the monitoring information based on the currently captured image when a difference between the captured image currently captured by the image capturing device and the captured image captured last time exists.

4. The remote monitoring device as claimed in claim 1, wherein the image capturing device is an event camera.

5. The remote monitoring device as claimed in claim 1, wherein the monitored object is a meter.

6. The remote monitoring device as claimed in claim 1, further comprising an illuminating light source coupled to the energy harvesting device, and the illuminating light source is adapted to illuminate the monitored object.

7. The remote monitoring device as claimed in claim 1, further comprising:
a wireless transmission module, coupled to the control circuit, wherein the control circuit transmits the monitoring information to an external device through the wireless transmission module.

8. The remote monitoring device as claimed in claim 7, wherein the wireless transmission module is further coupled to the image capturing device, and the image capturing device transmits the captured image to the external device through the wireless transmission module.

9. The remote monitoring device as claimed in claim 1, wherein the monitoring information comprises at least one of the captured image and interpretation information obtained from the control circuit interpreting the captured image.

10. The remote monitoring device as claimed in claim 1, wherein the energy harvesting device comprises:
an energy conversion element, adapted to convert ambient energy into electrical energy; and
a battery, coupled to the energy conversion element, adapted to store the electrical energy provided by the energy conversion element.

11. The remote monitoring device as claimed in claim 1, wherein the control circuit is integrated in the image capturing device.

12. A remote monitoring method of a remote monitoring device, the remote monitoring device comprising an energy harvesting device and an image capturing device, the energy harvesting device converting energy harvested from a surrounding environment into electrical energy for storage, and the remote monitoring method of the remote monitoring device comprising:
controlling the image capturing device to capture an image of a monitored object to generate a captured image;
determining whether power stored in the energy harvesting device reaches a preset power level; and
when the power stored in the energy harvesting device meets a preset condition, outputting monitoring information based on the captured image.

13. The remote monitoring method of the remote monitoring device as claimed in claim 12, comprising:
outputting the monitoring information based on the captured image when the power stored in the energy harvesting device reaches the preset power level.

14. The remote monitoring method of the remote monitoring device as claimed in claim 12, further comprising:
analyzing the captured image generated by the image capturing device, and outputting the monitoring information based on the currently captured image when a difference between the captured image currently captured and the captured image captured last time by the image capturing device exists.

15. The remote monitoring method of the remote monitoring device as claimed in claim 12, wherein the image capturing device is an event camera.

16. The remote monitoring method of the remote monitoring device as claimed in claim 12, wherein the monitored object is a meter.

17. The remote monitoring method of the remote monitoring device as claimed in claim 12, further comprising:
providing an illuminating light source to illuminate the monitored object.

18. The remote monitoring method of the remote monitoring device as claimed in claim 12, wherein the monitoring information comprises at least one of the captured image and interpretation information obtained from a control circuit interpreting the captured image.
